(19) United States
(12) Patent Application Publication
(10) Pub. No.: US 2026/0048635 A1
(43) Pub. Date: Feb. 19, 2026

(54) CONTROLLING LATERAL DYNAMICS OF A VEHICLE

(71) Applicant: Rivian IP Holdings, LLC, Irvine, CA (US)

(72) Inventors: Karthik MOHAN, Santa Ana, CA (US); Mark George MILNE, Irvine, CA (US)

(21) Appl. No.: 19/257,159

(22) Filed: Jul. 1, 2025

Related U.S. Application Data
(60) Provisional application No. 63/682,747, filed on Aug. 13, 2024.

(51) Int. Cl. B60G 17/018; B60G 17/016

(52) U.S. Cl. CPC B60G 17/018; B60G 17/016; B60G 2400/0513; B60G 2400/104; B60G 2400/204; B60G 2400/40; B60G 2500/10

(57) ABSTRACT

A vehicle includes suspensions including dampers. The dampers are controlled by a control system that receives two or more input signals relating to body roll of the vehicle and normalizes the two or more input signals to obtain two or more normalized signals. The two or more normalized signals are combined and the combined signal and a speed of the vehicle are used to calculate a common damper force. The common damper force is used to calculate, for each wheel of a plurality of wheels of the vehicle, a damper force corresponding to each wheel. The operation of a damper for a wheel is then commanded according to the damper force corresponding to that wheel. The two or more input signals relating to body roll may include steering rate, lateral acceleration, lateral jerk, and yaw rate.

### INTRODUCTION

This application claims the benefit of U.S. Provisional Application Ser. No. 63/682,747 filed Aug. 13, 2024, and entitled CONTROLLING LATERAL DYNAMICS OF A VEHICLE.

### INTRODUCTION

The present disclosure relates to controlling lateral dynamics of a vehicle.

### SUMMARY

In one aspect, a control system for use in a vehicle is configured to receive two or more input signals relating to body roll of the vehicle, combine the two or more input signals to obtain a combined signal, and calculate a common damper force based on the combined signal and a speed of the vehicle. The control system processes the common damper force to calculate, for each wheel of a plurality of wheels of the vehicle, a damper force corresponding to each wheel. The control system is configured to command operation of a damper of the vehicle corresponding to each wheel of the plurality of wheels of the vehicle according to the damper force corresponding to each wheel.

In another aspect, a vehicle includes a chassis, a plurality of wheels, and a plurality of suspensions connecting the plurality of wheels to the chassis, each suspension of the plurality of suspensions including a damper. The vehicle includes a control system configured to receive two or more input signals relating to body roll of the vehicle, normalize the two or more input signals to obtain two or more normalized signals, and combine the two or more normalized signals to obtain a combined signal. The control system calculates a common damper force based on the combined signal and a speed of the vehicle. The control system processes the common damper force to calculate, for each wheel of a plurality of wheels of the vehicle, a damper force corresponding to each wheel. The control system commands operation of a damper of the vehicle corresponding to each wheel of the plurality of wheels of the vehicle according to the damper force corresponding to each wheel.

In another aspect, a damper control method includes receiving, by a control system of a vehicle, two or more input signals relating to body roll of the vehicle and normalizing, by the control system, the two or more input signals to obtain two or more normalized signals. The control system combines the two or more normalized signals to obtain a combined signal and calculates a common damper force based on the combined signal and a speed of the vehicle. The control system processes the common damper force to calculate, for each wheel of a plurality of wheels of the vehicle, a damper force corresponding to each wheel. The control system commands operation of a damper of the vehicle corresponding to each wheel of the plurality of wheels of the vehicle according to the damper force corresponding to each wheel.

### BRIEF DESCRIPTION OF THE DRAWINGS

FIG. 1A illustrates an example vehicle that may be operated in accordance with certain embodiments.

FIG. 1B illustrates a chassis of a vehicle having multiple drive units that may be operated in accordance with certain embodiments.

FIG. 2 is a schematic block diagram of components for operating the vehicle in accordance with certain embodiments.

FIG. 3A is schematic block diagram defining forces and directions relating to controlling dynamics of a vehicle.

FIG. 3B is a schematic diagram illustrating a suspension of a vehicle.

FIG. 4 is a schematic block diagram of an approach for controlling dampers of a vehicle in accordance with an embodiment of the present invention.

FIGS. 5A and 5B are plots of input signals relating to body roll in accordance with an embodiment of the present invention.

### DETAILED DESCRIPTION

A vehicle suspension includes springs (e.g., coil, leaf, or air springs) to absorb impacts to wheels of the vehicle in order to facilitate stable handling of the vehicle and increase passenger comfort. The suspension further includes dampers to limit movement of the vehicle chassis relative to the wheels. In particular, dampers may be used to limit body roll (rotation about the longitudinal axis of the vehicle). In the approach described herein, the force exerted by dampers is controlled by valves that control the flow of hydraulic fluid responsive to movement of wheels relative to the vehicle chassis. The force exerted by a damper is determined based on drive mode, vehicle speed, and values relating to body roll, such as lateral acceleration, steering rate, lateral jerk (rate of change of lateral acceleration), and yaw rate.

Tuning of the operation of the dampers is simplified and enabled by normalizing and combining signals relating to body roll into a single signal that is then used to obtain a common damper force value based on other variables, such as vehicle speed and drive mode. The common damper force is further processed in a straightforward manner to determine damper force to be developed at each damper. Using this approach, the number of tunable parameters is reduced while still accounting for multiple signals relating to body roll. The tuning of a vehicle suspension is therefore simplified while still enabling desired vehicle dynamics to be achieved.

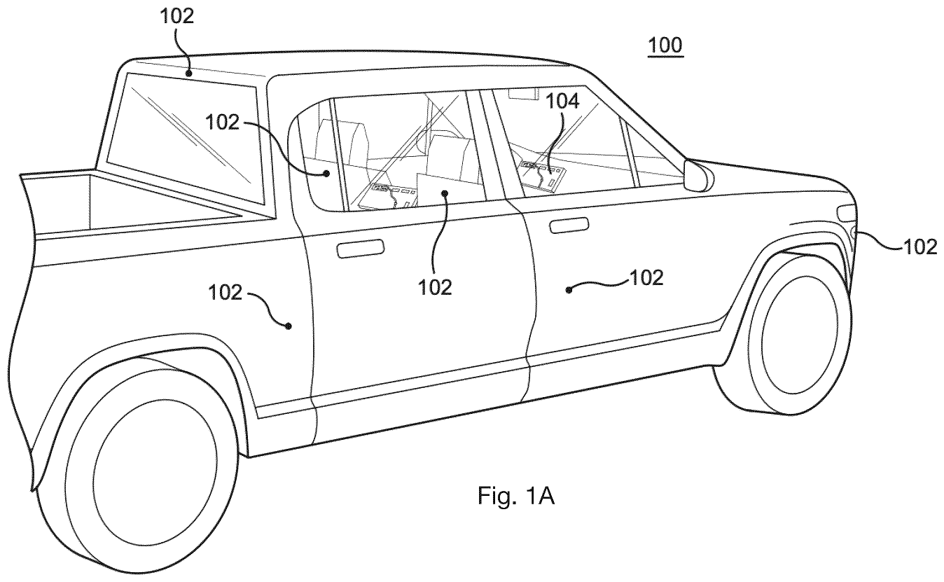

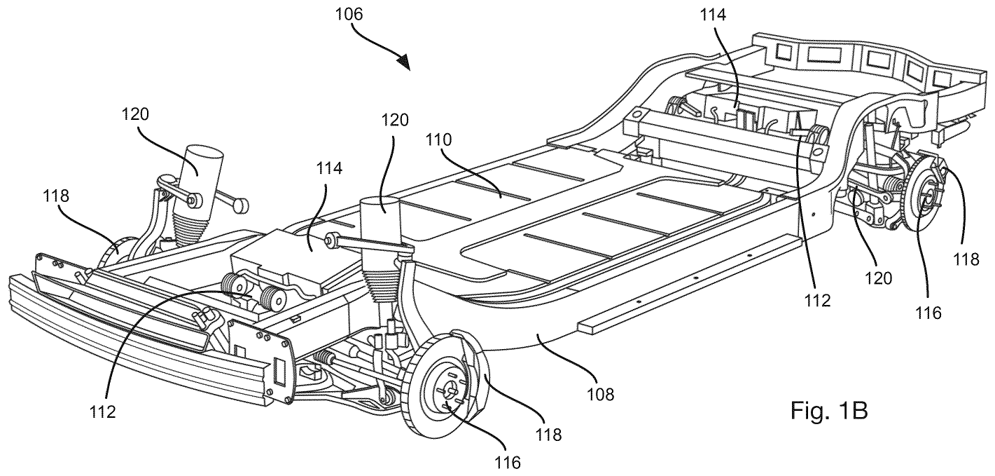

FIG. 1A illustrates an example vehicle 100 in which the approach described herein may be implemented. As seen in FIG. 1A, the vehicle 100 has multiple exterior cameras 102 and one or more front displays 104. Each of these exterior cameras 102 may capture a particular view or perspective on the outside of the vehicle 100. The images or videos captured by the exterior cameras 102 may then be presented on one or more displays in the vehicle 100, such as the one or more front displays 104, for viewing by a driver.

Referring to FIG. 1B, the vehicle 100 may include a chassis 106 including a frame 108 providing a primary structural member of the vehicle 100. The frame 108 may be formed of one or more beams or other structural members or may be integrated with the body of the vehicle (e.g., unibody construction).

In embodiments where the vehicle 100 is a battery electric vehicle (BEV) or possibly a hybrid vehicle, a large battery 110 is mounted to the chassis 106 and may occupy a substantial (e.g., at least 80 percent) of an area within the frame 108. For example, the battery 110 may store from 100 to 200 kilowatt hours (kWh). The battery 110 may be a lithium-ion battery or other type of rechargeable battery. The battery may be substantially planar in shape.

Power from the battery 110 may be supplied to one or more drive units 112. Each drive unit 112 may be formed of an electric motor and possibly a gear train providing a gear reduction. In some embodiments, there is a single drive unit 112 driving either the front wheels or the rear wheels of the vehicle 100. In another embodiment, there are two drive units 112, each driving either the front wheels or the rear wheels of the vehicle 100. In yet another embodiment, there are four drive units 112, each drive unit 112 driving one of four wheels of the vehicle 100.

Power from the battery 110 may be supplied to the drive units 112 by one or more sets of power module 114, such as power module for each drive unit 112 or pair of drive units 112. The power module 114 may include inverters configured to convert direct current (DC) from the battery 110 into alternating current (AC) supplied to the motors of the drive units 112. The power module 114 further facilitate operation of the motors of the drive units as generators to provide regenerative braking. The power module 114 further facilitate the transfer of regenerative current to the battery 110.

The drive units 112 are coupled to two or more hubs 116 to which wheels may mount. Each hub 116 includes a corresponding brake 118, such as the illustrated disc brakes. Each hub 116 is further coupled to the frame 108 by a suspension 120. The suspension 120 may include metal or pneumatic springs for absorbing impacts. The suspension 120 may be implemented as a pneumatic or hydraulic suspension capable of adjusting a ride height of the chassis 106 relative to a support surface. The suspension 120 may include a damper with the properties of the damper being either fixed or adjustable electronically.

In the embodiment of FIGS. 1B and 1n the discussion below, the vehicle 100 is a battery electric vehicle. However, a hybrid-electric vehicle may also benefit from the approach described herein. Likewise, non-vehicular applications that use an inverter or other relevant power component may also benefit from the approach described herein.

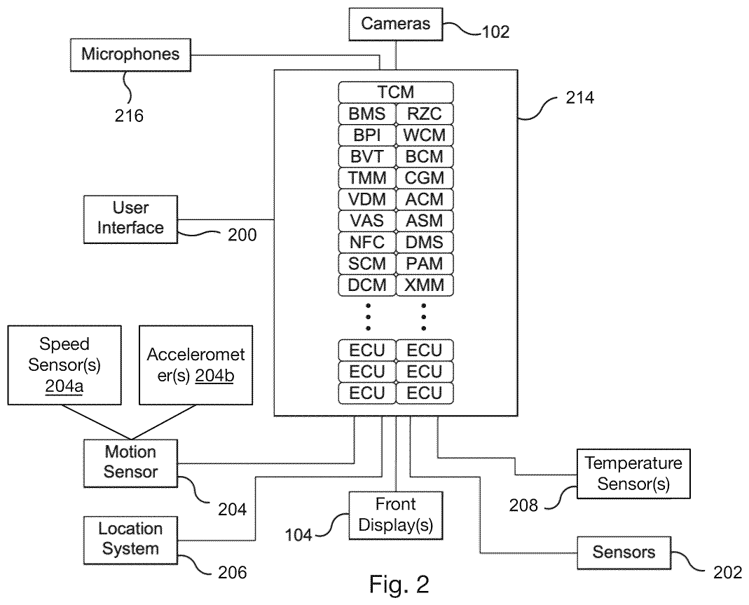

FIG. 2 illustrates example components of the vehicle 100 of FIG. 1A. As seen in FIG. 2, the vehicle 100 includes the cameras 102, the one or more front displays 104, a user interface 200, one or more sensors 202, a motion sensor 204 (e.g., a vehicle speed sensor 204a, accelerometer 204b, or other type of motion sensor), and a location system 206. The one or more sensors 202 may include ultrasonic sensors, radio detection and ranging (RADAR) sensors, light detection and ranging (LIDAR) sensors, or other types of sensors. The location system 206 may be implemented as a global positioning system (GPS) receiver. The user interface 200 allows a user, such as a driver or passenger in the vehicle 100, to provide input.

The components of the vehicle 100 may include one or more temperature sensors 208. The temperature sensors 208 may include sensors configured to sense an ambient air temperature, temperature of the battery 110, temperature of a power module 114, temperature of each drive unit 112 and/or each motor of each drive unit 112, temperature of coolant fluid entering or leaving a coolant system, temperature of oil within a drive unit 112, or the temperature of any other component of the vehicle 100. The temperature sensors 208 may include a temperature sensor directly mounted to a microprocessor of the power module 114 as described in greater detail below.

A control system 214 executes instructions to perform at least some of the actions or functions of the vehicle 100. For example, as shown in FIG. 2, the control system 214 may include one or more electronic control units (ECUs) configured to perform at least some of the actions or functions of the vehicle 100, including the functions described below. In certain embodiments, each of the ECUs is dedicated to a specific set of functions.

Certain features of the embodiments described herein may be controlled by a Telematics Control Module (TCM) ECU. The TCM ECU may provide a wireless vehicle communication gateway to support functionality such as, by way of example and not limitation, over-the-air (OTA) software updates, communication between the vehicle and the internet, communication between the vehicle and a computing device, in-vehicle navigation, vehicle-to-vehicle communication, communication between the vehicle and landscape features (e.g., automated toll road sensors, automated toll gates, power dispensers at charging stations), or automated calling functionality.

Certain features of the embodiments described herein may be controlled by a Central Gateway Module (CGM) ECU. The CGM ECU may serve as the vehicle's communications hub that connects and transfer data to and from the various ECUs, sensors, cameras, microphones, motors, displays, and other vehicle components. The CGM ECU may include a network switch that provides connectivity through Controller Area Network (CAN) ports, Local Interconnect Network (LIN) ports, and Ethernet ports. The CGM ECU may also serve as the master control over the different vehicle modes (e.g., road driving mode, parked mode, off-roading mode, tow mode, camping mode), and thereby control certain vehicle components related to placing the vehicle in one of the vehicle modes.

In various embodiments, the CGM ECU collects sensor signals from one or more sensors of vehicle 100. For example, the CGM ECU may collect data from cameras 102, sensors 202, motion sensor 204, location system 206, and temperature sensors 208. The sensor signals collected by the CGM ECU are then communicated to the appropriate ECUs for processing.

The control system 214 may also include one or more additional ECUs, such as, by way of example and not limitation: a Vehicle Dynamics Module (VDM) ECU, an Experience Management Module (XMM) ECU, a Vehicle Access System (VAS) ECU, a Near-Field Communication (NFC) ECU, a Body Control Module (BCM) ECU, a Seat Control Module (SCM) ECU, a Door Control Module (DCM) ECU, a Rear Zone Control (RZC) ECU, an Autonomy Control Module (ACM) ECU, an Autonomous Safety Module (ASM) ECU, a Driver Monitoring System (DMS) ECU, and/or a Winch Control Module (WCM) ECU.

If vehicle 100 is an electric vehicle, one or more ECUs may provide functionality related to the battery pack of the vehicle, such as a Battery Management System (BMS) ECU, a Battery Power Isolation (BPI) ECU, a Balancing Voltage Temperature (BVT) ECU, and/or a Thermal Management Module (TMM) ECU. In various embodiments, the XMM ECU transmits data to the TCM ECU (e.g., via Ethernet, etc.). Additionally or alternatively, the XMM ECU may transmit other data (e.g., sound data from microphones 216, etc.) to the TCM ECU.

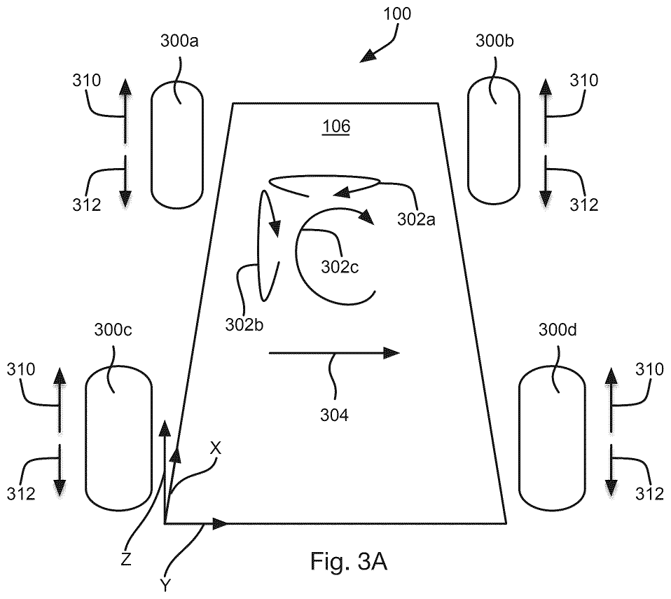

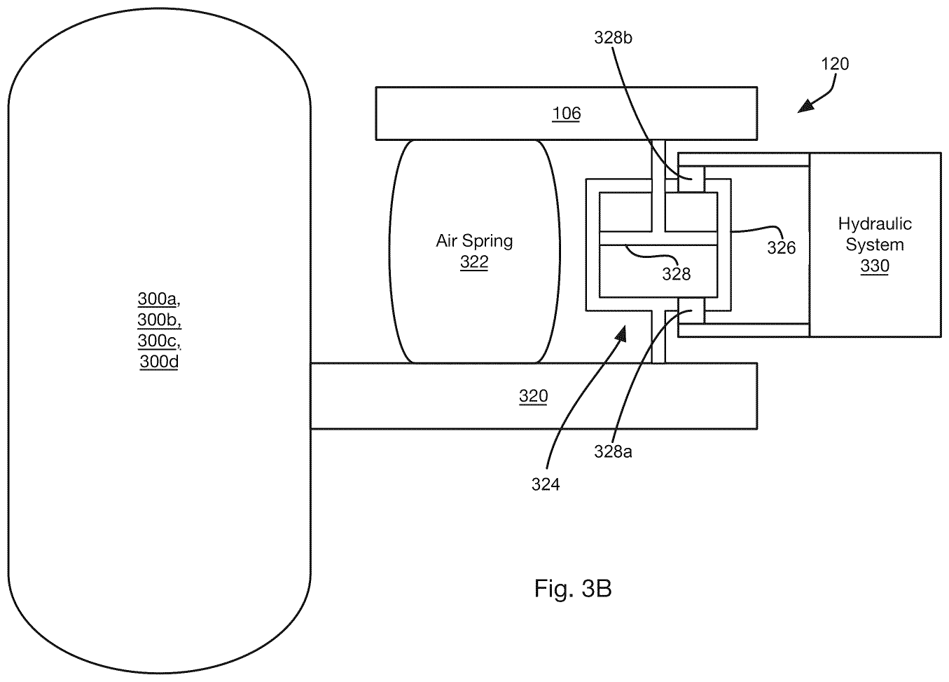

Referring to FIG. 3A, dynamics of the chassis 106 relative to the wheels of the vehicle 100 may be understood with respect to X, Y, and Z directions that are all mutually perpendicular. The X direction (also referred to as the longitudinal direction) may be defined as the direction of travel of the vehicle 100 when traveling in a straight line, the Z direction (also referred to as the vertical direction) may be understood as the direction of gravity when the vehicle 100 is on a flat support surface. The Y direction (also referred to as the lateral direction) is perpendicular to the X and Y directions.

The wheels of the vehicle 100 may include a left front wheel 300a, right front wheel 300b, left rear wheel 300c, and right rear wheel 300d. The front wheels 300a, 300b are typically steered, though all-wheel steering is also possible. Motion of the chassis 106 relative to the wheels 300a-300d may include body roll 302a, (rotation about an axis parallel to the X direction), pitch 302b (rotation about an axis parallel to the Y direction), and yaw 302c (rotation about an axis parallel to the Z direction). Lateral acceleration 304 as discussed herein may be defined as acceleration parallel to the Y direction. Lateral jerk as discussed herein may be defined as the first derivative of the lateral acceleration 304.

The suspension 120 for each wheel 300a-300d may independently control the forces resisting movement of chassis 106 relative to the wheel 300a-300d in two directions that are generally (e.g., within 10 degrees of) parallel to the Z direction. These forces may include a compression force 310 resisting compression of the suspension 120, e.g., movement of the chassis 106 downwardly along the Z direction relative to the wheel 300a-300d and a rebound force 312 resisting expansion of the suspension 120, e.g., movement of the chassis 106 upwardly along the Z direction relative to the wheel 300a-300d.

FIG. 3B illustrates a simplified representation of a suspension 120 for a wheel 300a-300d. The suspension 120 may include a spring interposed between the chassis 106 and a linkage 320 connecting the wheel 300a-300d to the chassis 106, such as a control arm. The spring may be an air spring 322 such that the effective spring constant of the air spring 322 may be dynamically changed in order to adjust the ride height of the vehicle 100 and compensate for steady state forces (e.g., low-frequency (e.g., less than 1 Hz)) causing body roll 302a. The air spring 322 may be replaced with any other type of spring, such as a coil or leaf spring. The air spring 322 provides a restoring force in response to forces exerted on the wheel 300a-300d and inertial forces exerted by the chassis 106.

The suspension 120 may likewise include a damper 324 connected between the chassis 106 and the linkage 320 and which resists movement of the chassis 106 relative to the wheel 300a-300d. The resistance is primarily (e.g., at least 90%) inelastic, e.g., due to viscous losses. The damper 324 may serve to limit oscillation caused by the spring-mass system formed by the chassis 106 and air spring 322. As discussed in greater detail below, the damper 324 may also be used to control the amount of body roll 302a during turning.

In some embodiments, the damper 324 is implemented as, or behaves analogously to, a cylinder 326 and piston 328 sliding within the cylinder 326. Hydraulic fluid within the cylinder 326 may be forced out of the cylinder 326 through valves 328a, 328b positioned on either side of the piston 328. For example, flow through the valve 328a may be induced by compression of the suspension 120 (chassis 106 moved toward the linkage 320) and therefore define the amount of compression force 310 exerted by the damper 324. Flow through the valve 328b may be induced by rebounding of the suspension 120 (chassis 106 moved away from the linkage 320) and therefore define the amount of rebound force 312 exerted by the damper 324. The valves 328a, 328b may be connected to one another: flow out of valve 328a flows into valve 328b, and vice versa. Alternatively, pressure downstream from the valves. 328a, 328b may be regulated by a hydraulic system 330 that provides a reservoir of hydraulic fluid and possibly maintains the pressure at the valves 328a, 328b.

Each wheel 300a-300d has a corresponding suspension 120 and components of that suspension (e.g., cylinder 326, valves 328a, 328b, cylinder 326) are referred to herein as corresponding to that wheel 300a-300d or the wheel 300a-300d corresponding to such components.

Although the examples herein reference hydraulic dampers, once a damper force is determined according to the approach described below, the damper force may be achieved using any type of damper known in the art.

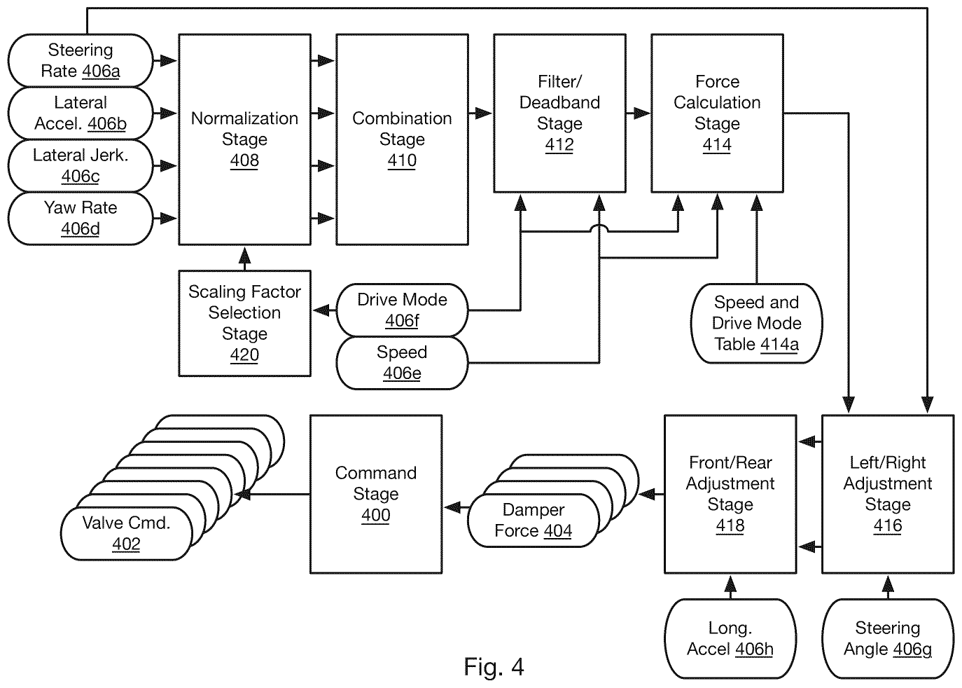

FIG. 4 illustrates an approach for controlling the valves 328a, 328b of the dampers 324. The approach of FIG. 4 may be implemented using the control system 214, such as one or more ECUs of the control system 214. For example, the vehicle dynamics module (VDM) may be used. The approach of FIG. 4 illustrates components and a corresponding method implemented by performing the functions ascribed to the components as described below.

In the approach of FIG. 4 a command stage 400 may generate a valve command 402 for each valve 328a, 328b of each suspension 120. The valve command 402 for a valve 328a, 328b may command a degree of opening of the valve 328a, 328b and the corresponding force (compression force 310 or rebounding force 312) exerted by the damper 324 including the valve 328a, 328b.

The command stage 400 may generate the valve command 402 for valves 328a, 328b corresponding to a wheel 300a-300d based on a damper force 404 determined for that wheel 300a-300d. FIG. 4 illustrates an approach for determining the damper forces 404 that is based on a large number of input signals while at the same time requiring tuning of relatively few parameters in order to achieve desired vehicle handling characteristics.

Input signals may include steering rate 406a, e.g., a rate of change in steering angle of steered wheels (e.g., the front wheels 300a, 300b) as imposed by the driver, an autonomous driving algorithm, or a combination thereof. The input signals may include lateral acceleration 406b and lateral jerk 406c as defined above. Lateral acceleration 406b may be sensed by an accelerometer 204b incorporated into the vehicle 100 and lateral jerk 406c may be calculated as the first derivative of the lateral acceleration 406b. Yaw rate 406d, e.g., rotation in yaw 302c, may likewise be derived from rotation sensed by the accelerometer 204b.

Other input signals may include a vehicle speed 406e as measured using a speed sensor 204a measuring rotation of one or more wheels 300a-300d or other component of a drive train of the vehicle 100. A currently selected drive mode 406f of the vehicle may also be used as an input. In some implementations steering angle 406g and longitudinal acceleration 406h (e.g., as sensed by the accelerometers 204b or based on driver inputs to an accelerator pedal and brake pedal) are also used as input signals.

As noted above, there are a large number of input signals 406a-406h. The benefits of the approach described herein may be achieved using only two or more of the input signals 406a-406d and vehicle speed 406c. In one example, steering rate 406a, lateral acceleration 406b, and lateral jerk 406c along with vehicle speed 406e are used. However, further refinements may be achieved using one or more additional input signals of the input signals 406a-406h as described in detail below.

A portion of the input signals are designated as “input signals relating to body roll” and may include, for example, the steering rate 406a and one or more of lateral acceleration 406b, lateral jerk 406c, or yaw rate 406d, such as at least lateral acceleration 406b and lateral jerk 406c. The input signals relating to body roll may be input to a normalization stage 408. Normalizing the input signals may include calculating the absolute value of each input signal and scaling the absolute value of the input signal such that each input signal ranges only between 0 and 1. For example, an input signal relating to body roll may be normalized according to (|S|/SF), where |S| is the absolute value of the signal (e.g., a sample of the signal) and SF is a scaling factor for the input signal. Normalization may include constraining the normalized value to be between 0 and 1. Where |S| cannot possibly exceed SF and/or a normalized value greater than 1 is tolerated, then (|S|/SF) may be used. Otherwise, other clamping approaches may be used (e.g., minimum (|S|/SF,1, (2/π)*atan(|S|/SF)).

The value of SF may be selected experimentally. For example, an instance of the vehicle 100 may be subjected to handling tests involving turns at various speeds and turning radii to determine safe operating limits of the vehicle 100 (e.g., avoiding rollover, skidding, understeer, oversteer, etc.). During such handling tests, values for the input signals relating to body roll while the vehicle 100 is operating within the safe operating limits may be measured and the maximum magnitude of the measurements for an input signal (possibly reduced by a safety factor) may be used as the value of SF for that input signal. As discussed in detail below, the value of SF may be selected based on such measurements and in view of other considerations

The output of the normalization stage 408 is a set of two or more normalized signals corresponding to the two or more input signals relating to body roll. The normalized signals may be processed by a combination stage 410 to obtain a single combined signal. The combination stage may combine the normalized signals by summing the normalized signals to obtain the combined signal. The combination stage may combine the normalized signals by taking the maximum of the normalized signals, e.g., the maximum sample of the normalized signals for a given time step.

The combined signal may be input to a filter/deadband stage 412. The filter/deadband stage 412 may low-pass filter the combined signal. The input signals relating to body roll and correspondingly the combined signal include high frequency components, e.g., noise, whereas the vehicle 100 has a relatively low frequency response, e.g., less than 2 Hz. Accordingly, the filter/deadband stage 412 may filter the combined signal with a low-pass filter to obtain a filtered signal. The low-pass filter may have a cut-off frequency (e.g., 3 dB cutoff frequency) of between 1.5 and 2.5 Hz, between 1.8 and 2.2 Hz, or between 1.9 and 2.1 Hz.

The filter/deadband stage 412 may clamp the filtered signal to zero under certain conditions, i.e., within a deadband. For example, at high vehicle speeds, changes in damping behavior for small variations in the input signals relating to body roll might not be helpful. Accordingly, the filter/deadband stage 412 may implement logic such as: if(FS[t]<F(V)), then FS[t]=0, where FS[t] is a sample in the filtered signal, V is the vehicle speed 406e, and F(V) is a function of vehicle speed that increases with increasing vehicle speed, e.g., the width of the deadband increases with increasing speed. F(V) may be implemented as a mathematical function, lookup table, or other logic.

The filter/deadband stage 412 may be a function of the drive mode 406f of the vehicle. For example, for a racing drive mode that emphasizes reducing body roll over comfort, the deadband may be reduced in width or eliminated. For a comfort drive mode that emphasizes comfort over reducing body roll, the deadband may be larger, e.g., F (V) for the comfort drive mode is larger relative to F (V) for the racing drive mode for a given vehicle speed V.

The filtered signal as output by the filter/deadband stage 412 may be input to a force calculation stage 414. The force calculation stage 414 uses the filtered signal and one or more input signals other than the input signals relating to body roll, such as the vehicle speed 406c and possibly the drive mode 406f. The output of the force calculation stage 414 is a common damper force that is used in subsequent stages to determine the specific damper force 404 for each valve 328a, 328b of each damper 324.

The force calculation stage 414 may calculate the common damper force using a table 414a that provides a common damper force based on a value of the filtered signal to a value for the common damper force and the vehicle speed 406e. The table 414a may be a three dimensional table that provides a common damper force for a value of the filtered signal, the vehicle speed 406e, and the drive mode 406f. The table 414a has a finite number of entries such that interpolation may be used. The table 414a may also be replaced with a mathematical function or programmatic logic for selecting the common damper force based on input variables (filtered signal, speed, and possibly drive mode).

The table 414a provides a single data structure through which speed and the inputs relating to body roll are accounted for to define the handling of the vehicle relating to the dampers 324. In particular, the table 414a provides a single data structure for dealing with transient body roll resulting from initiation of a turn, ending a turn, and changes to steering angle during a turn. The table therefore provides a convenient data structure for a designer to test possible vehicle behaviors when tuning the handling of the vehicle 100 relating to the dampers 324.

The common damper force output by the force calculating stage 414 may be input to a left/right adjustment stage 416. The left/right adjustment stage 416 may further take, as an input, the steering rate 406a and possibly the steering angle 406g. The left/right adjustment stage 416 determines the sign of damping force (e.g., compression force 310 or rebound force 312) exerted by the damper 324 of each wheel 300a-300d) and may further make adjustments to the common damper force. The output of the left/right adjustment stage 416 may be a left damper force and a right damper force.

As noted above, the normalization stage 408 may take the absolute value of input signals relating to body roll such that the common damper force is agnostic of the direction of body roll. Accordingly, the left/right adjustment stage 416 may determine the sign (e.g., compression force 310=positive; rebound force 312=negative) of the left damper force and the right damper force with the magnitude of the force being determined based on the common damper force.

For example, a positive steering rate may be defined as increased steering to the left and a negative steering rate may be defined as increased steering to the right. Likewise, a positive steering angle may be defined as to the right of a straight-ahead position of the steered wheels and a negative steering angle may be defined as to the left of the straight ahead position. The left/right adjustment stage 416 may use the steering rate 406a, and possibly the steering angle 406g to determine the left damper force and the right damper force.

For example, a positive (left) steering rate may indicate a tendency toward body roll to the right such that the right damper force is positive (non-zero compression force 310) and the left damper force is negative (non-zero rebound force 312). A negative (right) steering rate may indicate a tendency toward body roll to the left such that the left damper force is positive and the right damper force is negative.

The magnitude of the left damper force and the right damper force may be set equal to the common damper force, half of the common damper force, or some other function of the common damper force. For example, whichever of the left and right damper force is positive may be set to P*C, and whichever of the left and right damper force is negative may be set to N*C, where C is the common damper force and P and N are predetermined values that may be non-equal. For example, P may be greater than N.

The left/right adjustment stage 416 may further take, as an input, the steering angle 406g. For example, the left and right damper force determined as described above may be adjusted based on steering angle 406g. In one use case, in response to a zero crossing of the steering angle 406g, e.g., change from a right turn to a left turn, the left and right damper force may be increased in magnitude relative to the magnitude based on the common damper force. In this manner, the corresponding valves 328a, 328b will be closed more rapidly in anticipation of a greater damper force requirement later as the turn progresses, allowing pressure in the cylinder 326 to begin increasing sooner and compensating for the delay inherent in changing the states of the valves 328a, 328b.

The left damper force and right damper force as determined by the left/right adjustment stage 416 may be input to a front/rear adjustment stage 418, which generates the damper forces 404. The front and rear suspensions 120 may be different (e.g., different spring constants) and the weight distribution on the front wheels 300a, 300b and on the rear wheels 300c, 300d may be different. Accordingly, the left damper force may be processed by the left/right adjustment stage 416 to obtain a front left damper force 404 and a rear left damper force 404. The right damper force may be processed by the left/right adjustment stage 416 to obtain a front right damper force 404 and a rear right damper force 404.

For example, the rear wheels 300c, 300d may be more loaded than the front wheels 300a, 300b based on loading of the vehicle 100 or inherent weight distribution of the vehicle 100. Accordingly, the front left damper force 404 may be calculated as F*LD and the rear left damper force may be calculated as R*LD, where LD is the left damper force and F and R are values selected to achieve a desired ratio between front and rear damper force. For example, R may be greater than F where the rear wheels 300c, 300d are more loaded than the front wheels 300a, 300b. Likewise, front right damper force 404 may be calculated as F*RD and the rear right damper force may be calculated as R*RD, where RD is the right damper force.

In some embodiments, the damper forces 404 may be further adjusted based on longitudinal acceleration. For example, during positive acceleration, loading is shifted to the rear wheels 300c, 300d and off the front wheels 300a, 300b. During negative acceleration (e.g., braking), loading is shifted off the rear wheels 300c, 300d and onto the front wheels 300a, 300b. The damper force 404 may be increased for whichever of the wheels 300a-300d is loaded more as a result of acceleration and decreased for whichever of the wheels 300a-300d is less loaded as a result of acceleration.

For example, the magnitude of the front left damper force 404 and front right damper force 404 may be adjusted or scaled by GF (a), and the rear left damper force 404 and rear right damper force 404 may be augmented or scaled by GR (a), where a is acceleration, GF (a) is a function of acceleration that decreases with increasing acceleration, and GR (a) is a function of acceleration that increases with increasing acceleration.

The command stage 400 uses the damper forces 404 to generate the valve commands 402. For example, a positive damper force 404 corresponding to wheel 300a-300d will result in closing of the valve 328a of the damper 324 corresponding to that wheels 300a-300d to achieve a compression force 310 corresponding in magnitude to the positive damper force 404 and opening of the valve 328b to reduce the rebound force 312. A negative damper force 404 corresponding to a wheel 300a-300d will result in opening of the valve 328a of the damper 324 corresponding to the wheel to reduce compression force 310 corresponding in magnitude to the positive damper force 404 and closing of the valve 328b to increase the rebound force 312 in correspondence with the magnitude of the negative damper force 404.

For example, the command stage 400 may generate the valve commands 402 as follows:
A positive front left damper force 404 may result in commanding corresponding closing of the valve 328a and opening of the valve 328b corresponding to wheel 300a.
A negative front left damper force may result in commanding corresponding opening of the valve 328a and closing of the valve 328b corresponding to wheel 300a.
A positive front right damper force 404 may result in commanding corresponding closing of the valve 328a and opening of the valve 328b corresponding to wheel 300b.
A negative front right damper force 404 may result in commanding corresponding opening of the valve 328a and closing of the valve 328b corresponding to wheel 300b.
A positive rear left damper force 404 may result in commanding corresponding closing of the valve 328a and opening of the valve 328b corresponding to wheel 300c.
A negative rear left damper force 404 may result in commanding corresponding opening of the valve 328a and closing of the valve 328b corresponding to wheel 300c.
A positive rear right damper force 404 may result in commanding corresponding closing of the valve 328a and opening of the valve 328b corresponding to wheel 300d.
A negative rear right damper force 404 may result in commanding corresponding opening of the valve 328a and closing of the valve 328b corresponding to wheel 300d.

The valve commands 402 may be input directly to actuators controlling opening and closing of the valves 328a, 328b or used as targets by one or more controllers controlling the actuators.

The system of FIG. 4 is exemplary only and various modifications may be made to further refine operation thereof. For example, the normalization stage 408 may be used to change the weighting of the input signals relating to body roll (steering rate 406a, lateral acceleration 406b, lateral jerk 406c, and yaw rate 406d). In one approach, the value of SF used to normalize an input signal may be selected by a scaling factor selection stage 420 based on drive mode 406f. In one example, for first (e.g., racing) drive mode, emphasis may be placed on steering rate 406a to reduce body roll and provide more responsiveness to driver inputs. Accordingly, the value of SF used to normalize the steering rate 406a may be decreased relative to other drive modes resulting in a greater contribution of steering rate 406a to the common damper force. In a second (e.g., comfort) drive mode, emphasis may be placed on comfort over reducing body roll and responsiveness such that the value of SF used to normalize the steering rate 406a may be greater than the value of SF used for the racing drive mode.

In another example modification, the input signals relating to body roll may be shaped (e.g., scaled, filtered, processed according to a transfer function, etc.) based on one or more other input signals, such as vehicle speed 406e and drive mode 406f either before normalization by the normalization stage 408 or in place of the function of the normalization stage. Shaping of the input signals relating to body roll may be performed based on look up tables, a mathematical function, programmed logic, or other approach.

In another example modification, the ordering of certain steps may be reversed. For example, in the normalization stage, scaling by SF may be performed prior to taking the absolute value. The ordering of filtering and clamping within a deadband may likewise be reversed relative to what is described above with respect to the filter/deadband stage 412. The ordering of the left/right adjustment stage 416 and the front/rear adjustment stage 418 may likewise be reversed. Accordingly, a front damper force and a rear damper force may be calculated first based on weight distribution, suspension configuration, and/or longitudinal acceleration 406h as described above. The front damper force may then be used to calculate the front left damper force 404 and front right damper force 404 based on steering rate 406a and possibly steering angle 406g. The rear damper force may then be used to calculate the rear left damper force 404 and rear right damper force 404 based on steering rate 406a and possibly steering angle 406g as described above.

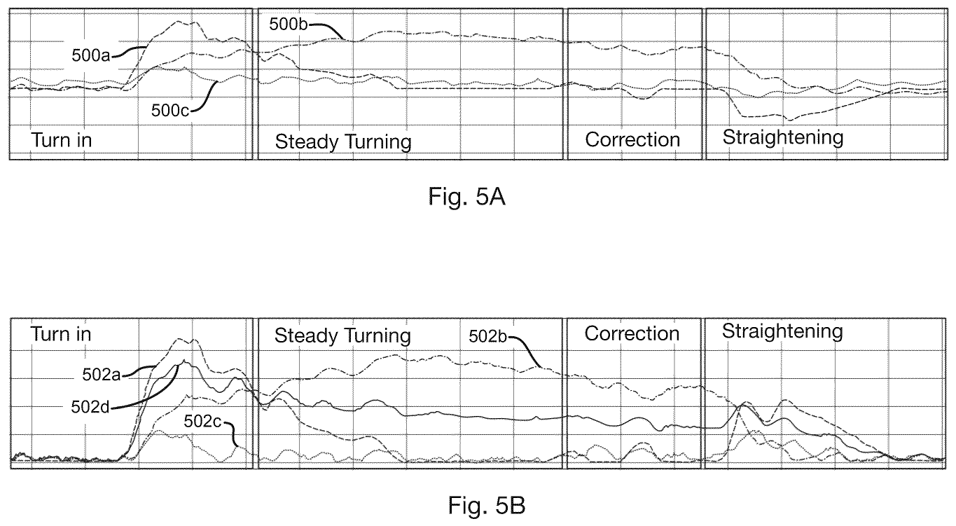

FIGS. 5A and 5B include plots of input signals relating to body roll and illustrate the operation of the system of FIG. 5. In FIG. 5A, plot 500a is a plot of steering rate (degrees per second), plot 500b is a plot of lateral acceleration (meters per second squared), and plot 500c is a plot of lateral jerk (meters per second cubed). In FIG. 5B, plot 502a is a plot of normalized steering rate, plot 502b is a plot of normalized lateral acceleration, and plot 502c is a plot of normalized lateral jerk. Plot 502d is a plot of the combined signal obtained from the normalized input signals. The plots of FIGS. 5A and 5B correspond to a turning event including turn in, steady turning (e.g., steering angle relatively constant), a mid-event correction, and straightening of the steered wheels at the end of the turning event.

As is readily apparent, prior to normalization, the magnitudes of these signals are very different. As is further apparent, following normalization, which of the normalized signals is larger varies throughout the turning event. For example, normalized steering rate (plot 502a) is dominant during turn in whereas normalized lateral acceleration (plot 502b) is dominant during steady turning. During the mid-event correction and straightening, all three normalized input signals contribute to the combined signal and exhibit peaks that occur at different times from one another. Using the approach described above, the combined signal obtained from the normalized signals captures the contribution of whichever of the input signals relating to body roll is dominant at a given stage of a turning event.

The combined signal further functions to smooth out variations in the individual input signals, resulting in smoother control of dampers 324, particularly during mid-event corrections and straightening. For example, during mid-event corrections, the normalized steering rate will tend to dictate the slope of the common damper force with further shaping by the normalized lateral acceleration and lateral jerk to reflect vehicle behavior. During straightening, all three normalized input signals are blended to ensure stable support for the vehicle when exiting the turning event.

The descriptions of the various embodiments of the present disclosure have been presented for purposes of illustration. Many modifications and variations will be apparent to those of ordinary skill in the art without departing from the scope and spirit of the described embodiments. The terminology used herein was chosen to explain the principles of the embodiments, the practical application or technical improvement over technologies found in the marketplace, or to enable others of ordinary skill in the art to understand the embodiments disclosed herein.

In the preceding, reference is made to embodiments presented in this disclosure. However, the scope of the present disclosure may exceed the specific described embodiments. Instead, any combination of the features and elements, whether related to different embodiments, is contemplated to implement and practice contemplated embodiments. Furthermore, although embodiments disclosed herein may achieve advantages over other possible solutions or over the prior art, the embodiments may achieve some advantages or no particular advantage. Thus, the aspects, features, embodiments and advantages discussed herein are merely illustrative.

While the foregoing is directed to embodiments of the present disclosure, other and further embodiments may be devised without departing from the basic scope thereof, and the scope thereof is determined by the claims that follow.

What is claimed is:

1. A control system for use in a vehicle, the control system configured to:
receive two or more input signals relating to body roll of the vehicle;
combine the two or more input signals to obtain a combined signal;
calculate a common damper force based on the combined signal and a speed of the vehicle;
process the common damper force to calculate, for each wheel of a plurality of wheels of the vehicle, a damper force corresponding to each wheel; and
command operation of a damper of the vehicle corresponding to each wheel of the plurality of wheels of the vehicle according to the damper force corresponding to each wheel.

2. The control system of claim 1, wherein the control system is configured to normalize the two or more input signals to obtain two or more normalized signals and combine the two or more normalized signals to obtain the combined signal.

3. The control system of claim 2, wherein the control system is configured to normalize each input signal of the two or more input signals by dividing an absolute value of each input signal by a scaling factor corresponding to each input signal.

4. The control system of claim 2, wherein the control system is configured to combine the two or more normalized signals by summing the two or more normalized signals.

5. The control system of claim 2, wherein the control system is configured to combine the two or more normalized signals by taking a maximum of the two or more normalized signals.

6. The control system of claim 1, wherein the control system is configured to calculate the common damper force based on the combined signal and the speed of the vehicle using a lookup table.

7. The control system of claim 1, wherein the control system is configured to calculate the common damper force based on the combined signal, the speed of the vehicle, and a drive mode of the vehicle.

8. The control system of claim 1, wherein the two or more input signals include a steering rate and lateral acceleration of the vehicle.

9. The control system of claim 8, wherein the two or more input signals include lateral jerk.

10. The control system of claim 9, wherein the two or more input signals include yaw rate of the vehicle.

11. The control system of claim 1, wherein the control system is configured to process the common damper force to calculate, for each wheel of the plurality of wheels of the vehicle, the damper force corresponding to each wheel by:
calculating a left damper force and a right damper force from the common damper force based on a steering rate of the vehicle; and
calculating the damper force corresponding to each left wheel of the plurality of wheels according to the left damper force and calculating the damper force corresponding to each right wheel of the plurality of wheels according to the right damper force.

12. The control system of claim 11, wherein the control system is configured to calculate the left damper force and the right damper force from the common damper force based on the steering rate and steering angle of the vehicle.

13. The control system of claim 11, wherein the control system is configured to calculate the damper force corresponding to each left wheel of the plurality of wheels according to the left damper force and calculate the damper force corresponding to each right wheel of the plurality of wheels according to the right damper force by:
calculating the damper force for a left front wheel of the plurality of wheels and for a left rear wheel of the plurality of wheels according to the left damper force and a longitudinal acceleration of the vehicle; and
calculating the damper force for a right front wheel of the plurality of wheels and for a right rear wheel of the plurality of wheels according to the right damper force and the longitudinal acceleration of the vehicle.

14. The control system of claim 1, wherein the control system is configured to:
calculate the common damper force based on the combined signal and the speed of the vehicle by filtering the combined signal using a low-pass filter to obtain a filtered signal; and
calculate the common damper force based on the filtered signal and the speed of the vehicle.

15. The control system of claim 14, wherein the low-pass filter has a cutoff frequency of 1.5 Hz to 2.5 Hz.

16. A vehicle comprising:
a chassis;
a plurality of wheels;
a plurality of suspensions connecting the plurality of wheels to the chassis, each suspension of the plurality of suspensions including a damper; and
a control system configured to:
receive two or more input signals relating to body roll of the vehicle;
combine the two or more input signals to obtain a combined signal;
calculate a common damper force based on the combined signal and a speed of the vehicle;
process the common damper force to calculate, for each wheel of a plurality of wheels of the vehicle, a damper force corresponding to each wheel; and
command operation of a damper of the vehicle corresponding to each wheel of the plurality of wheels of the vehicle according to the damper force corresponding to each wheel.

17. The vehicle of claim 16, wherein the control system is configured to wherein the control system is configured to normalize the two or more input signals to obtain two or more normalized signals and combine the two or more normalized signals to obtain the combined signal.

18. The vehicle of claim 17, wherein the control system is configured to combine the two or more normalized signals by one of summing the two or more normalized signals and taking a maximum of the two or more normalized signals.

19. The vehicle of claim 16, wherein the control system is configured to calculate the common damper force based on the combined signal, the speed of the vehicle, and a drive mode of the vehicle.

20. A damper control method comprising:
receiving, by a control system of a vehicle, two or more input signals relating to body roll of the vehicle;
combining, by the control system, the two or more input signals to obtain a combined signal;
calculating, by the control system, a common damper force based on the combined signal and a speed of the vehicle;
processing, by the control system, the common damper force to calculate, for each wheel of a plurality of wheels of the vehicle, a damper force corresponding to each wheel; and
commanding, by the control system, operation of a damper of the vehicle corresponding to each wheel of the plurality of wheels of the vehicle according to the damper force corresponding to each wheel.
